(19) United States
(12) Patent Application Publication
(10) Pub. No.: US 2020/0033595 A1
(43) Pub. Date: Jan. 30, 2020

(54) METHOD AND SYSTEM FOR CALIBRATING A WEARABLE HEADS-UP DISPLAY HAVING MULTIPLE EXIT PUPILS

(71) Applicant: NORTH INC., Kitchener (CA)

(72) Inventor: Cory Stegelmeier, Waterloo (CA)

(21) Appl. No.: 16/412,574

(22) Filed: May 15, 2019

Related U.S. Application Data
(60) Provisional application No. 62/702,756, filed on Jul. 24, 2018.

(51) Int. Cl. G02B 27/00; G02B 27/01

(52) U.S. Cl. CPC G02B 27/0081; G02B 27/0179; G02B 27/0093; G02B 2027/0174; G02B 2027/0143; G02B 2027/0187; G02B 27/0172

(57) ABSTRACT

A method of calibrating a wearable heads-up display includes generating visible light that is representative of the white color of the pixels of a display UI by a plurality of light sources of the wearable heads-up display and projecting the visible light to an exit pupil of the wearable heads-up display. A measured white point of the exit pupil is determined from the visible light received at the exit pupil. The measured white point of the exit pupil is compared to a target white point, and a set of factors by which to scale the power of the light sources is determined based on the comparison. The method may be applied to all the exit pupils of the wearable heads-up display such that the wearable heads-up display has a uniform white point across all the exit pupils.

### CROSS-REFERENCE TO RELATED APPLICATIONS

This application claims the benefit of U.S. Provisional Application No. 62/702756, filed 24 Jul. 2018, titled “Method and System for Calibrating a Wearable Heads-Up Display Having Multiple Exit Pupils”, the content of which is incorporated herein in its entirety by reference.

### TECHNICAL FIELD

The disclosure relates generally to display performance of wearable heads-up displays and particularly to color calibration of a wearable heads-up display.

### BACKGROUND

A scanning light projector (SLP)-based wearable heads-up display (WHUD) is a form of virtual retinal display in which a SLP draws a raster scan onto the eye of the user. In the absence of any further measure, the SLP projects light over a fixed area called the exit pupil of the display. In order for the user to see displayed content, the exit pupil typically needs to align with, be encompassed by, or overlap with the entrance pupil of the eye of the user. The full resolution and/or field of view (FOV) of the display is visible to the user when the exit pupil of the display is completely contained within the entrance pupil of the eye. For this reason, a SLP-based WHUD often employs a relatively small exit pupil that is equal to or smaller than the expected size of the entrance pupil of the user's eye. The normal pupil size in adults varies from 2 mm to 4 mm in diameter in bright light and 4 mm to 8 mm in the dark, and the exit pupil size may be selected based on the expected smallest size of the pupil or average size of the pupil.

The term “eyebox” means “the volume of space within which an effectively viewable image is formed by a lens system or visual display.” When the pupil of the eye is positioned inside this volume, the user is able to see all of the content on the display. On the other hand, when the pupil is outside of this volume, the user will not be able to see at least some of the content on the display. The size of the eyebox is directly related to the size of the exit pupil of the display. A WHUD that employs a small exit pupil in order to achieve maximum display resolution and/or FOV typically has a relatively small eyebox, which may mean that the eye does not have to move much before the pupil leaves the eyebox and the user is no longer able to see at least some of the displayed content. The eyebox may be made larger by increasing the size of the exit pupil of the display, but this typically comes at the cost of reducing the display resolution and/or field of view.

U.S. Pat. No. 9,989,764 (Alexander et al.) describes a scanning laser-based WHUD that expands the eyebox by exit pupil replication. The expansion is achieved by positioning an optical splitter in an optical path between a scanning laser projector and a holographic combiner. The optical splitter receives the light from the scanning laser projector, creates multiple instances of the light at spatially-separated positions, and directs the multiple light instances to the holographic combiner, which converges each light instance to a respective display exit pupil at the eye of the user. Thus, the eyebox is expanded by optically replicating a relatively small exit pupil and spatially distributing multiple instances of the exit pupil over the area of the eye.

In display systems using multiple exit pupils to expand the eyebox, at any instance, the pupil of the eye of the user may be aligned with one of the exit pupils or portions of several of the exit pupils of the display. Thus, the virtual retinal display may be composed of an image from one of the exit pupils of the display or image portions from several of the exit pupils of the display. In order to allow the user to see a quality image, e.g., one that is not blurry and does not suffer from color separation, the image portions displayed in the virtual retinal display would need to be overlapped and aligned. There are several aspects to aligning the image portions in the virtual retinal display, such as color, geometry, and brightness of the images received at the exit pupils.

### SUMMARY

A method of calibrating a WHUD having multiple exit pupils includes calibrating a white point of at least one exit pupil to a target white point. The calibration of the white point of the at least one exit pupil may be summarized as including: for each pixel of a plurality of pixels of a display UI, the plurality of pixels having a white color, generating visible light that is representative of the white color of the pixel by a plurality of light sources of the WHUD and projecting the visible light to the at least one exit pupil by the WHUD; determining a measured white point of the at least one exit pupil from at least a portion of the visible light received at the at least one exit pupil; and determining a set of factors by which to scale a power of each of the plurality of light sources based on minimizing a difference between the measured white point of the at least one exit pupil and the target white point.

The calibration of the white point of the at least one exit pupil may further include generating the display UI.

The calibration of the white point of the at least one exit pupil may further include storing the set of factors for the at least one exit pupil in a memory.

The method of calibrating the WHUD may further include repeating calibrating a white point of at least one exit pupil to a target white point for each of the remaining exit pupils and storing the set of factors for each of the exit pupils in a memory.

In the calibration of the white point of the at least one exit pupil, generating visible light that is representative of the white color of the pixel by a plurality of light sources of the WHUD may include generating a red light that is representative of a red portion of the white color of the pixel by a first one of the plurality of light sources, generating a green light that is representative of a green portion of the white color of the pixel by a second one of the plurality of light sources, and generating a blue light that is representative of a blue portion of the white color of the pixel by a third one of the plurality of light sources.

Determining a measured white point of the at least one exit pupil from at least a portion of the visible light received at the at least one of the exit pupils may include capturing an image represented by the at least a portion of the visible light received at the at least one exit pupil. Projecting the visible light to the at least one exit pupil by the WHUD may include separately projecting each of the red light, the green light, and the blue light to the at least one exit pupil by the WHUD. Determining a measured white point of the at least one exit pupil from at least a portion of the visible light received at the at least one exit pupil may further include measuring relative intensities of the red light, the green light, and the blue light projected to the at least one exit pupil.

Projecting the visible light to the at least one exit pupil by the WHUD may include aggregating the red light, the green light, and the blue light into a single combined beam and projecting the single combined beam to the at least one exit pupil by the WHUD. Determining a measured white point of the at least one exit pupil from at least a portion of the visible light received at the at least one exit pupil may include measuring a spectral power distribution of the at least a portion of the visible light. Determining a measured white point of the at least one exit pupil from at least a portion of the visible light received at the at least one exit pupil may further include determining chromaticity coordinates of the measured white point in a select color space from the measured spectral power distribution. Determining a measured white point of the at least one exit pupil from at least a portion of the visible light received at the at least one of the exit pupils may further include translating the chromaticity coordinates to r, g, and b values, where r is spectral radiance of the red light, g is spectral radiance of the green light, and b is spectral radiance of the blue light.

In the calibration of the white point of the at least one exit pupil, determining a set of factors by which to scale a power of each of the plurality of light sources based on minimizing a difference between the measured white point of the at least one exit pupil and the target white point may include determining a distance in a color space between the measured white point and the target white point.

In the method of calibrating the WHUD, calibrating a white point of at least one exit pupil to a target white point includes calibrating the white point of the at least one exit pupil to a standard white point representing daylight.

In the method of calibrating the WHUD, calibrating a white point of at least one exit pupil to a target white point includes calibrating the white point of the at least one exit pupil to CIE Standard Illuminant D65.

In the calibration of the white point of the at least one exit pupil, projecting the visible light to the at least one exit pupil by the WHUD may include projecting the visible light along a projection path of the WHUD including an optical scanner and a holographic combiner.

In the calibration of the white point of the at least one exit pupil, projecting the visible light to the at least one exit pupil by the WHUD may include projecting the visible light along a projection path including an optical scanner, an optical splitter having a plurality of facets on a light coupling surface thereof, each facet to receive visible light from the optical scanner for a select subset of a scan range of the optical scanner, and a holographic combiner.

A WHUD calibration system may be summarized as including: a WHUD having multiple exit pupils, the WHUD including a scanning laser projector to project light to the exit pupils; a light detector positioned and oriented to detect visible light projected to at least one of the exit pupils, the light detector to measure a select characteristic of the visible light, the select characteristic including at least one of intensity and spectral power distribution; a calibration processor communicatively coupled to the WHUD and light detector; and a non-transitory processor-readable storage medium communicatively coupled to the calibration processor, wherein the non-transitory processor-readable storage medium stores data and/or processor-executable instructions that, when executed by the processor, calibrates a white point of at least one of the exit pupils to a target white point.

In the WHUD system, the WHUD may include a processor, and the calibration processor may be communicatively coupled to the processor of the WHUD.

In the WHUD system, the light detector may include at least one of a spectral detector, camera, and an image sensor.

A system for calibrating a WHUD having multiple exit pupils may be summarized as including: a light detector positioned and oriented to detect visible light projected to at least one exit pupil by the WHUD, the light detector to measure a select characteristic of the visible light, the select characteristic including at least one of intensity and spectral power distribution; a calibration processor communicatively coupled to the light detector and the WHUD; and a non-transitory processor-readable storage medium communicatively coupled to the calibration processor. The non-transitory processor-readable storage medium may store data and/or processor-executable instructions that, when executed by the calibration processor, cause the system to: for each pixel of a plurality of pixels of a display UI, the plurality of pixels having a white color, generate, by a plurality of light sources of the WHUD, visible light that is representative of the white color of the pixel; measure, by the light detector, a characteristic of at least a portion of the visible light received at the at least one exit pupil; determine a measured white point of the at least one exit pupil from the measured characteristic; and determine a set of factors by which to scale each of the plurality of light sources of the WHUD based on minimizing a difference between the measured white point and a target white point.

In the system, the non-transitory processor-readable storage medium may store data and/or processor-executable instructions that, when executed by the processor, further cause the system to generate the display UI with the plurality of pixels having a white color.

The foregoing general description and the following detailed description are exemplary of the invention and are intended to provide an overview or framework for understanding the nature of the invention as it is claimed. The accompanying drawings are included to provide further understanding of the invention and are incorporated in and constitute part of this specification. The drawings illustrate various implementations or embodiments of the invention and together with the description serve to explain the principles and operation of the invention.

### BRIEF DESCRIPTION OF DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 is a front elevational view of a WHUD according to one implementation of the present disclosure.

FIG. 2A is a schematic diagram of multiple exit pupils of a WHUD on an eye, where the pupil is aligned with portions of the multiple exit pupils.

FIG. 2B is a schematic diagram of multiple exit pupils of a WHUD on an eye, where the pupil is primarily aligned with one of the exit pupils.

FIG. 3 is a schematic diagram of a WHUD according to one implementation of the present disclosure.

FIG. 4 is a schematic diagram illustrating mapping of frame buffer regions to facets of an optical splitter.

FIG. 5 is a block diagram showing interaction of an application processor with a display engine of the WHUD.

FIG. 6 is a block diagram of a setup for calibrating a white point of a WHUD according to one implementation of the present disclosure.

FIG. 7 is a block diagram showing interaction of a processor running a white point calibration app with an application processor of a WHUD according to one implementation of the present disclosure.

FIG. 8 is a flowchart illustrating a method of calibrating a white point of a WHUD according to one implementation of the present disclosure.

FIG. 9 is a flowchart illustrating a method of calibrating a white point of a WHUD according to another implementation of the present disclosure.

### DETAILED DESCRIPTION

In the following description, certain specific details are set forth in order to provide a thorough understanding of various disclosed implementations or embodiments. However, one skilled in the relevant art will recognize that implementations or embodiments may be practiced without one or more of these specific details, or with other methods, components, materials, etc. In other instances, well-known structures associated with portable electronic devices and head-worn devices have not been shown or described in detail to avoid unnecessarily obscuring descriptions of the implementations or embodiments. For the sake of continuity, and in the interest of conciseness, same or similar reference characters may be used for same or similar objects in multiple figures. For the sake of brevity, the term “corresponding to” may be used to describe correspondence between features of different figures. When a feature in a first figure is described as corresponding to a feature in a second figure, the feature in the first figure is deemed to have the characteristics of the feature in the second figure, and vice versa, unless stated otherwise.

In the disclosure, unless the context requires otherwise, throughout the specification and claims which follow, the word “comprise” and variations thereof, such as, “comprises” and “comprising” are to be construed in an open, inclusive sense, that is as “including, but not limited to.”

In the disclosure, reference to “one implementation” or “an implementation” or to “one embodiment” or “an embodiment” means that a particular feature, structures, or characteristics may be combined in any suitable manner in one or more implementations or one or more embodiments.

In the disclosure, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the disclosure provided herein are for convenience only and do not interpret the scope or meaning of the embodiments or implementations.

The term “user” refers to a subject wearing the wearable heads-up display (WHUD).

The term “display user interface” or “display UI” refers to the visual elements that will be shown in a display space and encompasses how the visual elements may respond to user inputs.

The term “eyebox” refers to a three-dimensional space where the pupil must be located in order to view the display UI. When the pupil is inside the eyebox the entire display UI is visible, including parts that may be outside of the eyebox.

The term “exit pupil” refers to a point on the eye where light projected by the display converges. A display may use multiple exit pupils to expand the eyebox.

The term “frame buffer” refers to a memory buffer containing at least one complete frame of data. The term “frame buffer image” may refer to the frame of data contained in the frame buffer.

A white point is a set of tristimulus values or chromaticity coordinates that serve to define the color “white” in image capture, encoding, or reproduction. The white point of an illuminant or of a display is the chromaticity of a white object under the illuminant or display and can be specified by chromaticity coordinates, such as the x, y coordinates on the CIE 1931 chromaticity diagram. (See, “White point,” Wikipedia, https://en.wikipedia.org/wiki/White_point, Web. 18 Jul. 2018.)

CIE Standard Illuminant D65 (“Illuminant D65”) is a commonly used standard illuminant defined by the International Commission on Illumination (CIE). Illuminant D65 is intended to represent daylight at a correlated color temperature of approximately 6500 K. Illuminant D65 is defined by its relative spectral power distribution over the range from 300 nm to 830 nm. The CIE 1931 color space chromaticity coordinates of illuminant D65 are: x=0.31271, y=0.32902. The chromaticity coordinates of illuminant D65 are a white point corresponding to a correlated color temperature of 6504 K. (See, “Illuminant D65,” Wikipedia, en.wikipedia.org/wiki/Illuminant_D65, Web. 18 Jul. 2018.)

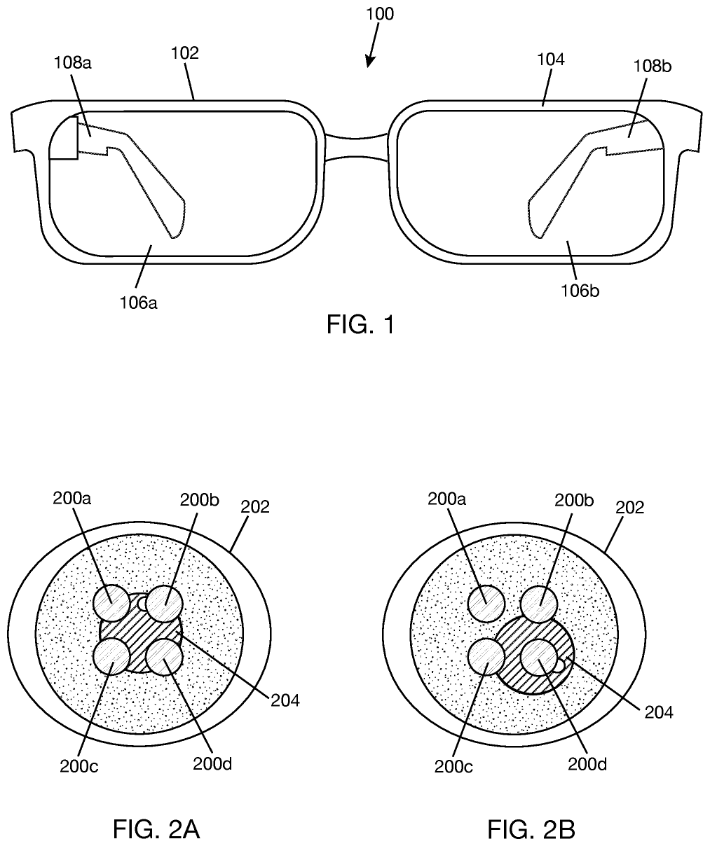

FIG. 1 illustrates a WHUD 100 having an appearance of eyeglasses (or a pair of glasses) according to one example. In other examples, WHUD 100 may take on other near-eye display forms, such as goggles and the like. WHUD 100 includes a support frame 102 that is worn on the head of a user when the WHUD is in use by the user. Support frame 102 carries the devices, electronics, and software that enable WHUD to project a display UI to the eye space of the user. In one example, support frame 102 includes a frame front 104 carrying a pair of transparent lenses 106a, 106b and temples 108a, 108b attached to opposite sides of the frame front 104. Many of the components of the WHUD 100 are carried by or within temples 108a, 108b. The components may be distributed between temples 108a, 108b such that the weights of temples 108a, 108b are generally balanced, although components that are optically coupled together will generally be carried by or within the same temple. Frame front 104 may also carry some components of WHUD 100, such as conductors that enable communication between components carried by or within temples 108a, 108b and antennas.

In one example, WHUD 100 may be a SLP-based WHUD that expands the eyebox by exit pupil replication. For illustrative purposes, FIGS. 2A and 2B show exit pupils 200a, 200b, 200c, 200d projected onto an eye 202 by a WHUD that expands the eyebox by exit pupil replication. Four exit pupils are shown on eye 202 in FIGS. 2A and 2B, although the number of exit pupils may generally be N≥1, where N is an integer. In one implementation, each exit pupil includes a visual representation of a respective copy of the display UI to be presented in the eye space. As the gaze direction of eye 202 changes, pupil 204 of eye 202 will move around. At any position of pupil 204, pupil 204 may be primarily aligned with one of the exit pupils 200a-200d, as illustrated in FIG. 2B, or with portions of several of the exit pupils 200a-200d, as illustrated in FIG. 2A. To allow the user to see a clear display UI, the copies of the display UI carried by the exit pupils overlap in the eye space. The display UI copies also need to be aligned at least in the region of the eye space where the display UI copies overlap. This generally requires aligning the corresponding image elements (pixels or points) of the display UI copies where the overlap occurs. Because of differences in optical path from the projector to the exit pupil for each of the exit pupils, the image element colors of the display UI may not be uniform across the exit pupils, which may lead to low quality image where the display UI copies overlap. Each exit pupil has a white point that is affected by the unique optical path along which light travels from the projector to the exit pupil. In one implementation of the present disclosure, to improve uniformity in image element colors across the exit pupils, the white points of the exit pupils are calibrated to the same target point, such as Illuminant D65 or other standard daylight illuminant.

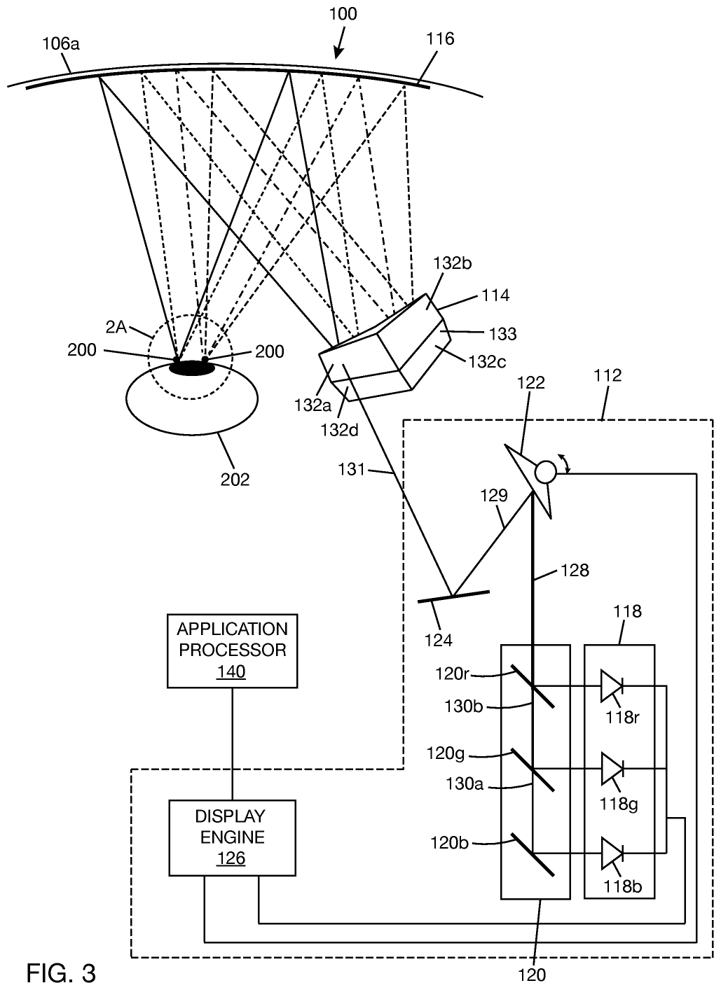

FIG. 3 is a schematic diagram of a portion of WHUD 100 positioned relative to eye 202 according to one illustrative implementation. In the interest of clarity and because WHUD 100 may be configured in multiple ways, not all of the components of WHUD 100 are shown in FIG. 3. In general, the components shown in FIG. 3 are the components relevant to projecting a display UI into the eye space. Further, all the components shown in FIG. 3 may be carried by the support frame 102 (in FIG. 1).

In FIG. 3, WHUD 100 includes a scanning light projector (SLP) 112, which may be carried, for example, by temple 108a (in FIG. 1). Over a scan period (or a total range of scan orientations), SLP 112 projects frame buffer image (or light encoded with the frame buffer image) to an optical splitter 114 (or raster scans frame buffer image over a surface of optical splitter 114). The frame buffer image may contain 1 to N copies of the display UI, where N is the number of exit pupils of the WHUD. For a WHUD that expands the eyebox by exit pupil replication, N>1. Each of the display UI copies in the frame buffer image may be intended for projection to a specific one of the exit pupils. The frame buffer image may contain less than N copies of the display UI if it is desired to project the display UI to less than all the exit pupils. Thus, over the scan period, optical splitter 114 may receive a frame buffer image and may output one or more display UI copies, depending on the number of display UI copies contained in the frame buffer image. Over the scan period, a transparent combiner 116 integrated with lens 106a receives the one or more display UI copies from optical splitter 114 and redirects each of the display UI copies to a respective one of the N exit pupils (see exit pupils 200a-200d in FIGS. 2A and 2B).

SLP 112 includes light source(s) to generate light. In one example, SLP 112 includes a laser module 118, which may include any combination of laser diodes to generate at least visible light. In one example, laser module 118 includes at least a red laser diode 118r, a green laser diode 118g, and a blue laser diode 118b. As used herein, the adjectives used before the term “laser diode” or “laser diodes” refer to a characteristic of the output of the laser diode or laser diodes, e.g., the wavelength(s) or band of wavelengths of light output by the laser diodes. Although not shown, laser module 118 may also include any combination of laser diodes to generate infrared light, which may be useful in eye tracking. In alternate examples, laser module 118 may be replaced with a light module using any number of combination of light sources besides laser diodes, such as LED, OLED, super luminescent LED (SLED), microLED, and the like.

SLP 112 may include a beam combiner 120 having optical elements 120r, 120g, 120b to receive the output beams from laser diodes 118r, 118g, 118b, respectively, and aggregate at least a portion of each of the output beams into a single combined beam 128. In the illustrated example, optical element 120b is positioned and oriented to receive an output beam of laser diode 118b and reflect at least a portion of the output beam of laser diode 118b towards optical element 120g, as shown at 130a. Optical element 120g is positioned and oriented and has characteristics to receive an output beam of laser diode 118g and beam 130a from optical element 120b, aggregate at least a portion of the output beam of laser diode 118g and beam 130a into a combined beam, as shown at 130b, and direct the combined beam 130b to optical element 120r. In one example, optical element 120g may be made of a dichroic material that is transparent to at least the blue wavelength generated by laser diode 118b and the green wavelength generated by laser diode 118g. Optical element 120r is positioned and oriented and has characteristics to receive an output beam of laser diode 118r and beam 130b from optical element 120g, aggregate at least a portion of output beam of laser diode 118r and beam 130b into single combined beam 128 that is directed towards optical scanner 122. In one example, optical element 120r may be made of a dichroic material that is transparent to at least the blue wavelength generated by laser diode 118b, the green wavelength generated by laser diode 118g, and the red wavelength generated by laser diode 118r.

SLP 112 includes an optical scanner 122 that is positioned, oriented, and operable to receive beam 128 from beam combiner 120 and produce deflected beam 129. There may be optics in the path of beam 128 between beam combiner 120 and optical scanner 122 to shape or apply other optical functions to beam 128. Such optical functions may even be integrated into optical splitter 114. Further, samples of beam 128 may be tapped for various purposes, such as determining the luminous intensity and color of beam 128. In one implementation, optical scanner 122 includes at least one scan mirror, but more typically two scan mirrors. In one example, optical scanner 122 may be a two-dimensional scan mirror operable to scan in two directions, for example, by oscillating or rotating with respect to two axes. In another example, optical scanner 122 may include two orthogonally-oriented mono-axis mirrors, each of which oscillates or rotates about its respective axis. The mirror(s) of optical scanner 122 may be microelectromechanical systems (MEMS) mirrors, piezoelectric mirrors, and the like. Optical scanner 122, or the scan mirror(s) of optical scanner 122 according to one implementation, receives beam 128 and produces deflected beam 129. Over a scan period, the angle of beam 129 changes with the scan orientation of the optical scanner 122 such that beam 131 that is produced by reflecting beam 129 moves over a scan area, i.e., surface 133 of optical splitter 114, in a raster pattern. Reflective optics 124 may receive beam 129 from optical scanner 122 and produce the reflected beam 131. It is also possible to position optical splitter 114 relative to optical scanner 122 such that optical splitter 122 receives beam 129 directly from optical scanner 122.

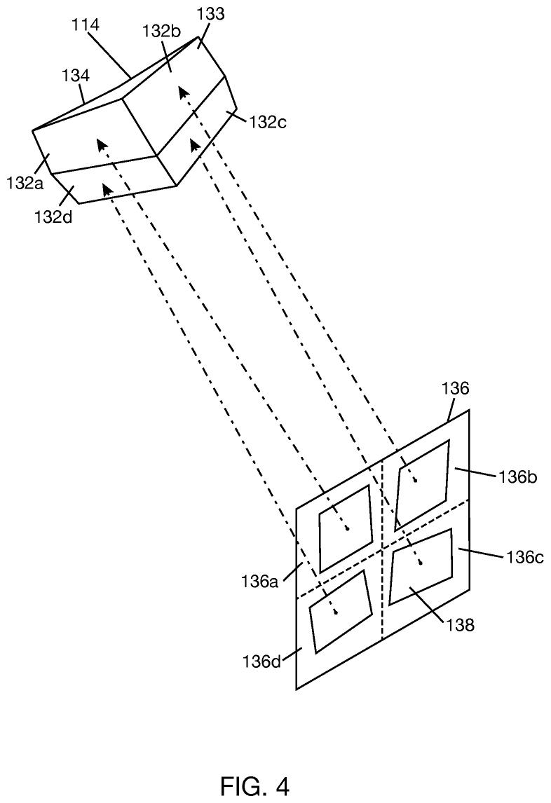

In one example, optical splitter 114 is a faceted optical structure formed out of a conventional optical material such as a plastic, glass, or fluorite. A faceted optical splitter for exit pupil replication is described in, for example, U.S. Pat. No. 9,989,764 (Alexander et al.), the disclosure of which is incorporated herein by reference. Over a scan period, from the perspective of the optical splitter 114, there is one input, i.e., frame buffer image or light encoded with frame buffer image, and up to N outputs (i.e., up to N copies of the display UI), where N is the number of exit pupils. For a WHUD that expands the eyebox by exit pupil replication, N>1. There are a number of ways of implementing this, and one example is illustrated in FIG. 4. In the example of FIG. 4, input surface 133 of optical splitter 114 has M facets. In one non-limiting example, M is at least equal to N, where N is the number of exit pupils. Continuing with N=4 as an example, input surface 133 is shown with at least 4 facets (optical elements) 132a, 132b, 132c, and 132d. Light may be coupled into the volume of optical splitter 114 through any of facets 132a, 132b, 132c, 132d, and light is coupled out of optical splitter 114 through surface 134 of optical splitter 114. (Output surface 134 may be faceted as well. Moreover, it is possible to turn the optical splitter 114 around such that surface 133 becomes the output side of the optical splitter and surface 134 becomes the input side of the optical splitter.)

For illustrative purposes, FIG. 4 shows a frame buffer 136 with regions 136a, 136b, 136c, 136d. In one example, each of the regions 136a, 136b, 136c, 136d includes a copy 138 of the display UI to be presented in the eye space. In one example, each region of the frame buffer 136 may be mapped to one of the facets of the optical splitter 114. Thus, for example, regions 136a, 136b, 136c, 136d of frame buffer 136 may be mapped to facets 132a, 132b, 132c, 132d, respectively, of optical splitter 114. (It should be understood that a different mapping may be used between the optical splitter and the frame buffer, e.g., optical splitter may have a plurality of facets where more than one facet corresponds to a region of the frame buffer.) The optical scanner (122 in FIG. 3) may have a sub-range of scan orientations corresponding to each of the facets of the optical splitter 144. Each facet of the optical splitter 144 may be oriented to receive light from the optical scanner for a particular sub-range of scan orientations. When the optical scanner is at a scan orientation corresponding to facet 132a, for example, the beam from the optical scanner will land on facet 132a. For the example illustrated in FIG. 4, the beam landing on facet 132a of the optical splitter 114 will contain a portion of the display data from region 136a of frame buffer 136. This can be extended to the other corresponding facets of the optical splitter 114 and regions of the frame buffer 136. Thus, effectively, the optical splitter 114 will produce N copies of the display UI from a frame buffer image projected onto the optical splitter 114 over a scan period, i.e., if the frame buffer image contains N copies of the display UI.

Although FIG. 4 shows frame buffer 136 containing N copies of the display UI, where N is the number of exit pupils, it is possible for the frame buffer to contain less than N copies of the display UI in other examples, e.g., if it is desired to project the display UI to less than all of the exit pupils. That is, some of the regions 136a, 136b, 136c, and 136d may not contain a copy of the display UI. In this case, optical splitter 114 may produce less than N copies of the display UI from the frame buffer image. In general, the number of copies of the display UI produced by optical splitter 114 will depend on the number of copies of display UI in frame buffer 136. It should also be noted that the copies of the display UI in the frame buffer may not be exactly identical to each other as each copy may include corrections specific to the exit pupil to which the copy is to be projected. However, the net effect of such corrections is generally that the copies of the display UI as received by the exit pupils represent the same display UI.

Returning to FIG. 3, optical combiner 116 receives the output images from the optical splitter 114 and directs each of the output images to a respective one of the exit pupils 200. Each of the output images may contain a respective copy (i.e., visual representation) of a display UI. Optical combiner 116 may be a free-space combiner. Free-space combiners. use one or more reflective, refractive, or diffractive optical elements to redirect light from a light source to a target. One example of a free-space combiner is a holographic combiner. In one example, optical combiner 116 may be a holographic combiner including at least one hologram that converges at least one of the output images to the respective exit pupil. Holographic combiner 116 may include at least one visible hologram in at least one layer of holographic material that is integrated with lens 106a. If the SLP 112 projects infrared light to the holographic combiner 116, holographic combiner 116 may also include at least one infrared hologram in the at least one layer of holographic material or another layer of holographic material. The holographic material may be, e.g., photopolymer and/or a silver halide compound. Each visible hologram is responsive to visible light and unresponsive to light outside of the visible range, such as infrared light. “Responsive,” herein, means that the hologram redirects at least a portion of the light, where the magnitude of the portion depends on the playback efficiency of the hologram. “Unresponsive,” herein, means that the hologram transmits the light, generally without modifying the light.

In one example, holographic combiner 116 may include one hologram that converges light over a relatively wide bandwidth. In another example, holographic combiner 116 may have multiplexed holograms, such as a red hologram that is responsive to red light, a green hologram that is responsive to green light, and a blue hologram that is responsive to blue light. The red hologram may converge a red component of the projected light to a respective one of the exit pupils, the blue hologram may converge a blue component of the projected light to a respective one of the exit pupils, and the green hologram may converge a green component of the projected light to a respective one of the exit pupils. In another example, holographic combiner 116 may include at least N angle-multiplexed holograms, where N is the number of exit pupils and is greater than 1. Each of the N angle-multiplexed holograms may be designed to playback for light effectively originating from one of the N facets of the optical splitter and converge the light to a respective one of the exit pupils. In general, holographic combiner 116 may include at least N multiplexed holograms and each one of the at least N multiplexed holograms may converge light corresponding to a respective one of the N facets of the optical splitter to a respective one of the N exit pupils.

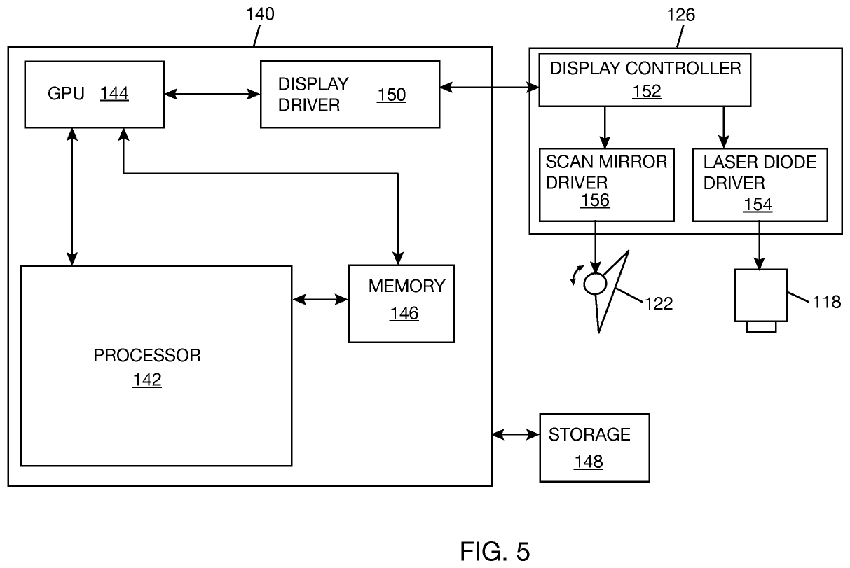

WHUD 100 may include an application processor 140, which is an integrated circuit (e.g., microprocessor) that runs the operating system and applications software. FIG. 5 shows an example of implementation of application processor 140 and interaction of application processor 140 with other systems in WHUD. In FIG. 5, application processor 140 may include a processor 142, GPU 144, and memory 146. Processor 142 and GPU 144 may be communicatively coupled to memory 146. Memory 146 may be a temporary storage to hold data and instructions that can be accessed quickly by processor 142 and GPU 144. Storage 148 may be a more permanent storage to hold data and instructions. Each of memory 146 and storage 148 may be a non-transitory processor-readable storage medium that stores data and instructions and may include one or more of random-access memory (RAM), read-only memory (ROM), Flash memory, solid state drive, or other processor-readable storage medium. Processor 142 may be a programmed computer that performs computational operations. For example, processor 142 may be a central processing unit (CPU), a microprocessor, a controller, an application specific integrated circuit (ASIC), system on chip (SOC) or a field-programmable gate array (FPGA).

In application processor 140, GPU 144 may receive display data from processor 142 and write the display data (render the display UI) into a frame buffer, which may be transmitted, through a display driver 150, to display controller 152 of display engine 126. Display controller 152 may provide the frame buffer data to laser diode driver 154 and scan mirror driver 156. Laser diode driver 154 may use the frame buffer data to generate the drive controls for the laser diodes in the laser module 118, and scan mirror driver 156 may use the frame buffer data to generate sync controls for the scan mirror(s) of the optical scanner 122. In one implementation, application processor 140 applies laser power scaling (or light power scaling, in general) to each copy of the display UI rendered into the frame buffer. In one implementation, the laser power scaling applied to each copy of the display UI is determined during calibration of display white point of the WHUD, as will be further explained below. Applying the laser power scaling at the frame buffer level allows the laser power scaling to be tailored for each exit pupil. It is possible to use a uniform laser power scaling for all the exit pupils, which may allow the laser power scaling to be applied at the point where the light is generated rather than at the point where the display UI is rendered into the frame buffer. However, this may not give fine control of the display white point per exit pupil.

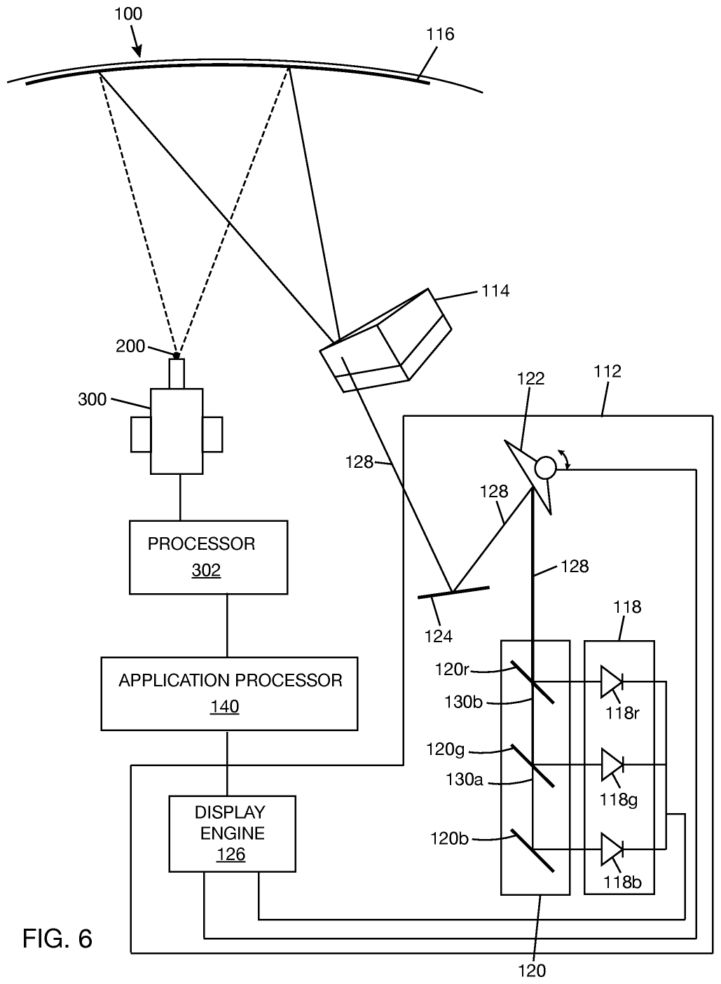

FIG. 6 shows a setup for calibrating a white point of an exit pupil of a WHUD to a target white point, such as Illuminant D65 or other standard white point representing daylight. The setup may be used to calibrate the white point of a single exit pupil or the white points of multiple exit pupils. The setup of FIG. 6 is similar to the system described in FIG. 4, except that in FIG. 6 a light detector 300 has replaced the eye (202 in FIG. 4). The light detector 300 is positioned at or proximate exit pupil 200 to measure at least one characteristic of light received at exit pupil 200—exit pupil 200 is representative of any of the N exit pupils of the display. The measured characteristic may be, for example, spectral power distribution, light intensity, or other characteristic from which light source power ratios may be determined. In one example, the light detector 300 may be a spectral detector, such as a spectrometer or spectroradiometer, or a camera or an image sensor in general. Light detector 300 may make light measurements at one exit pupil 200 at a time or at multiple exit pupils at a time. To make light measurements at one exit pupil at a time, light may be projected to only the exit pupil of interest (e.g., by projecting a frame buffer image that has data in only the region corresponding to the exit pupil of interest). To make light measurements at multiple exit pupils, light may be projected to the multiple exit pupils (e.g., by projecting a frame buffer image that has data in all the regions corresponding to the exit pupils of interest).

In the setup of FIG. 6, a calibration processor 302 is communicatively coupled to light detector 300 for calibration of a white point of one or more exit pupils of the WHUD. Calibration processor 302 may also be communicatively coupled to application processor 140 for the purpose of calibrating the white point of the exit pupil(s). The adjective “calibration” before processor 302 is generally used to distinguish this processor from other processor(s) used for normal operation of the WHUD, although, conceivably, the functionality of the calibration processor may be performed by a processor used in normal operation of the WHUD. In general, a processor that executes a white point calibration process as described herein may be referred to as a calibration processor. In addition, calibration processor 302 may be a programmed computer that performs computational operations. For example, processor 302 may be a central processing unit (CPU), a microprocessor, a controller, an application specific integrated circuit (ASIC), system on chip (SOC) or a field-programmable gate array (FPGA). Although not shown, a display screen may be communicatively coupled to calibration processor 302 to allow interaction with a calibration program running on calibration processor 302 and/or to allow calibration processor 302 to display calibration results from the calibration program.

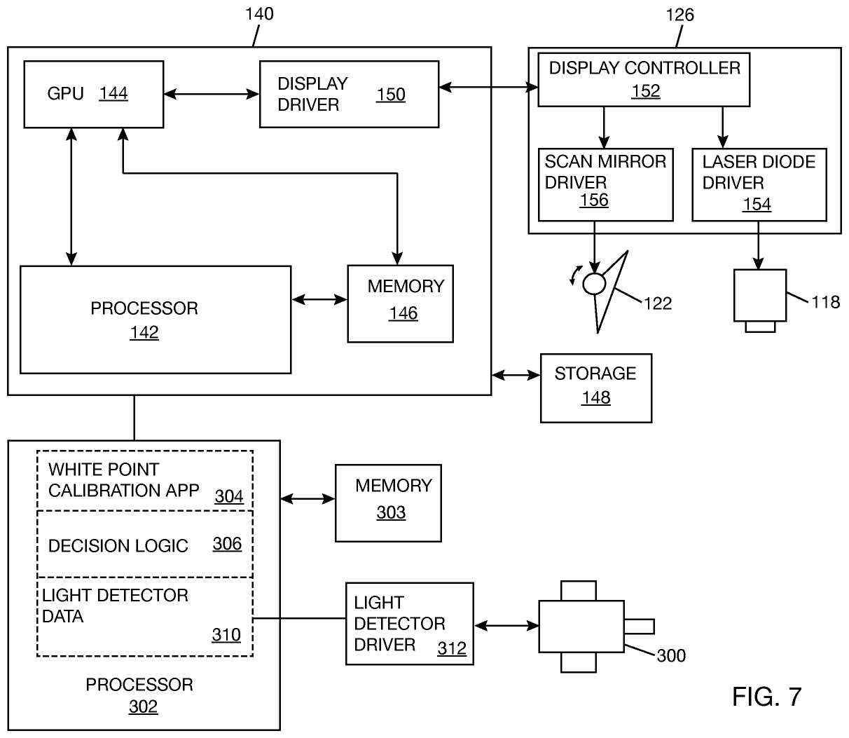

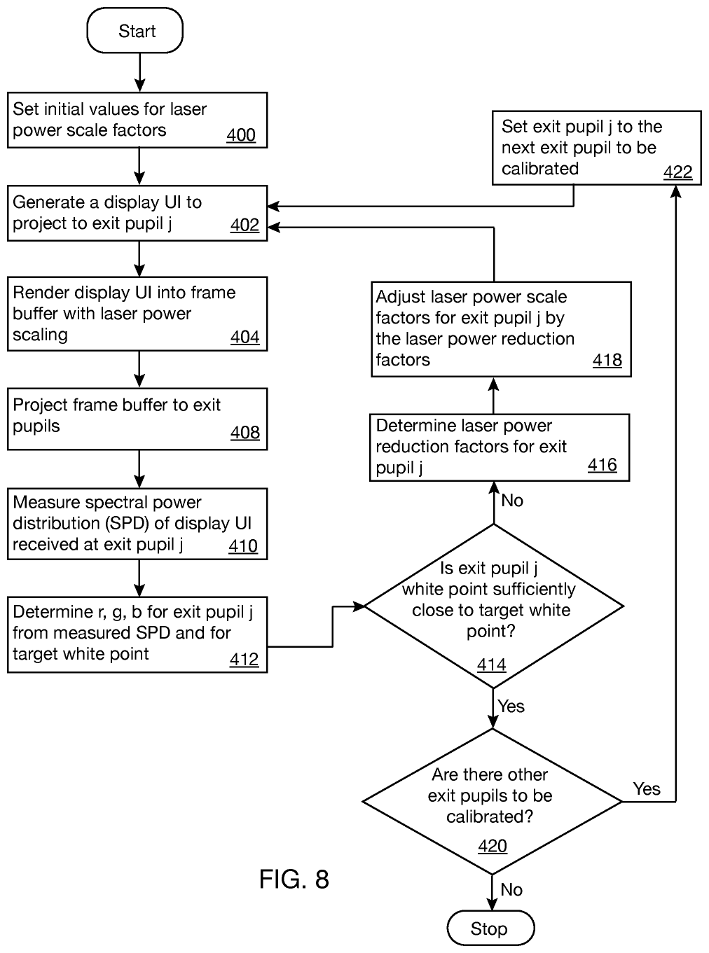

FIG. 7 shows a possible interaction between calibration processor 302 and application processor 140. In FIG. 7, calibration processor 302 is shown as executing instructions of a white point calibration application (“white point calibration app”) or program 304. White point calibration app 304 may be stored in memory 303 and accessed by calibration processor 302 at run time. White point calibration app 304 includes decision logic 306, which when executed by calibration processor 302 calibrates the white point of each of the exit pupils, or of at least one exit pupil, of the WHUD to a target white point. An example of decision logic 306 is illustrated in FIG. 8. White point calibration app 304 may receive light detector data 310 from light detector 300, e.g., through light detector data driver 312. Light detector data 310 may be, for example, spectral power distribution, intensity, or other characteristic of light from which power ratios of the light sources producing the light can be determined.

In one example, when white point calibration app 304 needs to project a display UI to an exit pupil as part of a white point calibration process, calibration processor 302 sends the display UI to application processor 140 with instructions to project the display UI to the exit pupil. Application processor 140 renders the display UI into a frame buffer (e.g., using OpenGL techniques), whose data is then used to control the laser module 118 and optical scanner 122. Light measurements may be made at one exit pupil at a time by rendering the display UI only into a region of the frame buffer corresponding to the exit pupil in a position to be sampled by light detector 300. If the light detector 300 is able to make light measurements at multiple exit pupils at a time, then the display UI may be rendered into each of multiple regions of the frame buffer corresponding to the multiple exit pupils. This means that each of the multiple regions of the frame buffer may contain a copy of the display UI.

FIG. 8 illustrates a method of calibrating a white point of an exit pupil j to a target white point according to one illustrative implementation, where j is a number from 1 to N, where N is the number of exit pupils of the display. In at least one example, N>1. Let Sᵣ, S_{g}, and S_{b} be a set of laser power scaling factors (or light source power scaling factors, in general), where Sᵣ is the scale factor to apply to the red component of light generated by the red laser diode (or red light source, in general), S_{g} is the scale factor to apply to the green component of light generated by the green laser diode (or green light source, in general), and S_{b} is the scale factor for the blue component of light generated by the blue laser diode (or blue light source, in general). At 400, a calibration processor (e.g., 302 in FIG. 7), assigns initial values to Sᵣ, S_{g}, and S_{b}. The initial values may be real numbers in [0, 1]. For convenience, the initial value of each of Sᵣ, S_{g}, and S_{b} may be set to 1.0, which corresponds to the allowable maximum of each of the red laser power, green laser power, and blue laser power. However, there is no particular restriction on what the initial values may be since they would be updated as part of the calibration process. For example, the initial values of Sᵣ, S_{g}, and S_{b} may be set based on previous white point calibration of other display devices with the same display architecture as the WHUD having the exit pupil j. Alternatively, the calibration processor may request the current values of the laser power scale factors stored in the WHUD and use the current values as the initial values of Sᵣ, S_{g}, and S_{b}.

At 402, the calibration processor may generate a display UI to use in the white point calibration. Alternatively, the calibration processor may retrieve a stored display UI to use in the white point calibration. The display UI may be stored in, e.g., memory 303 in FIG. 7, or elsewhere that is accessible to calibration processor. Alternatively, the calibration processor may request the WHUD to generate the display UI or retrieve the display UI from memory. For example, the WHUD may include one or more display UIs in a memory for testing purposes, and the calibration processor may simply use one of the test display UIs for white point calibration. In one example, the display UI to use in the white point calibration is a shape, e.g., a rectangular shape, square shape, or other shape, made of pixels. In one example, each of the pixels of the display UI has a white color. For example, the white color may be defined relative to the RGB color space (or another color space). In the RGB color space, each pixel may have the color represented by RGB=(255, 255, 255), where R is the red component of light, G is the green component of light, and B is the blue of light in an RGB color space. In another example, at least a portion of the display UI has pixels with the white color.

At 404, the application processor renders the display UI into the frame buffer of the projector. For example, the calibration processor may request the application processor of the WHUD to render the display UI into the frame buffer. Rendering the display UI into the frame buffer includes applying the laser power scale factors, determined at 400, to each pixel of the display UI. In one example, each pixel may be considered as having sub-pixels made of red component, blue component, and green component. The combination of the colors of the sub-pixels will give the pixel color. The laser power scale factors may be applied to these sub-pixels. In one implementation, the frame buffer has multiple regions, each region corresponding to one of the exit pupils of the display. In one non-limiting example, for calibration of only the white point of exit pupil j, the display UI is rendered only into the frame buffer region corresponding to exit pupil j. In an alternative example, the display UI may be rendered into each of the multiple regions of the frame buffer, i.e., each region will contain a copy of the display UI. However, for calibration of exit pupil j, it generally suffices to render the display UI only into the frame buffer region corresponding to exit pupil j.

At 408, the frame buffer is projected to the exit pupils. For example, this may include the display engine generating laser controls according to the display data in the frame buffer. That is, for each of the frame buffer pixels, laser controls are generated for the red laser diode, the green laser diode, and the blue laser diode. In general, each copy of the display UI rendered into the frame buffer may be considered as having three image portions corresponding to the three channels, i.e., red image portion, green image portion, and blue image portion. Therefore, the red portion of the display UI determines the laser controls for the red laser diode, the green portion of the display UI determines the laser controls for the green laser diode, and the blue portion of the display UI determines the laser controls for the blue laser diode. The red light, green light, and blue light generated by the respective laser diodes are aggregated into a single combined beam and projected, e.g., via the optical scanner, optical splitter, and optical combiner, to the exit pupil. In one example, projection of the display UI (or copies of the display UI) contained in the frame buffer to one exit pupil (or multiple exit pupils) involves raster scanning the frame buffer image across an input surface of the optical splitter by the optical scanner. The optical combiner (e.g., 116 in FIG. 6) receives each beam exiting the optical splitter (e.g., 114 in FIG. 6) and redirects the beam to the respective exit pupil.

In one example, the frame buffer may contain a single copy of the display UI for the exit pupil j that is being calibrated. In this case, only the exit pupil j that is being calibrated will receive the display UI when the frame buffer is projected to the exit pupils at 408. In another example, the frame buffer may contain multiple copies of the display UI, each copy of the display UI corresponding to one of the exit pupils, and the laser diodes may be operated only when projecting the portion of the frame buffer data corresponding to exit pupil j that is being calibrated. This is generally to allow the white point of exit pupil j to be measured independent of influence from light projected to the other exit pupils. However, it is possible to allow all the exit pupils to simultaneously receive a respective copy of the display UI in alternate implementations of the calibration process.

At 410, a characteristic of the display UI projected to exit pupil j is measured. In one example, this may include measuring a spectral power distribution of the display UI (or light) received at exit pupil j. The spectral power distribution may be measured using a spectral detector, such as a spectrometer or spectroradiometer. One example of a spectral detector that may be used is Gamma Scientific GS-1160 or GS-1160B Display Measurement System. However, any reasonably accurate spectral detector could be used. In one example, the spectral detector is configured with a circular field of view. However, a non-circular field of view may also be used. In one example, the size of the circular field of view may be in a range from 1 to 10 degrees. In general, the size of the circular field of view may be selected to be within the size of field of view of the WHUD. For calibration of the white point of exit pupil j, the WHUD and spectral detector are positioned relative to each other such that the sensitive area of the spectral detector is in the middle of the exit pupil j and is rotated to look at the center of the exit pupil j. This is done so that a color sample can be obtained from the center of the exit pupil, which is expected to be more representative of the exit pupil than anywhere else.

Gamma Scientific GS-1160 or GS-1160B Display Measurement System offers two measuring modes: CIE 1931 chromaticity mode and CIE 1976 chromaticity mode. The following is a procedure for converting CIE 1931 X, Y, Z to ratio of red, green, and blue power. If the chosen spectral detector does not output CIE 1931 X, Y, Z, the output of the spectral detector can usually be converted to CIE 1931 X, Y, Z. For example, CIE 1931 x, y chromaticity coordinates or CIE 1976 u′, v′ chromaticity coordinates may, with some measure of luminance, be converted to CIE 1931 X, Y, Z.

CIE 1931 X, Y, Z are defined as:

X=∫L_{e,Ω,λ}X̅(λ)dλ (1a)

Y=∫L_{e,Ω,λ}Y̅(λ)dλ (1b)

Z=∫L_{e,Ω,λ}Z̅(λ)dλ (1c)

where:

λ represents wavelength;

X̅ is a spectral color matching function for X;

Y̅ is a spectral color matching function for Y;

Z̅ is a spectral color matching function for Z; and

L_{e,Ω,λ} is spectral radiance.

For a laser projector with only three dominant (red, green, and blue) wavelengths, Equations (1a) to (1c) can be approximated as:

X=X̅(λᵣ)·r+X̅(λ_{g})·g+X̅(λ_{b})·b (2a)

Y=Y̅(λᵣ)·r+Y̅(λ_{g})·g+Y̅(λ_{b})·b (2b)

Z=Z̅(λᵣ)·r+Z̅(λ_{g})·g+Z̅(λ_{b})·b (2c)

where λᵣ represents the red wavelength, λ_{g} represents the green wavelength, λ_{b} represents the blue wavelength, r represents spectral radiance for red light, g represents spectral radiance for green light, and b represents spectral radiance for blue light.

This can be interpreted as the following matrix equation:

$$[ \begin{matrix}\overline{X} ( {λ}_{r} ) & \overline{X} ( λ g ) & \overline{X} ( {λ}_{b} ) \\ \overline{Y} ( {λ}_{r} ) & \overline{Y} ( {λ}_{g} ) & \overline{Y} ( {λ}_{b} ) \\ \overline{Z} ( {λ}_{r} ) & \overline{Z} ( {λ}_{g} ) & \overline{Z} ( {λ}_{b} )\end{matrix} ] [ \begin{matrix}r \\ g \\ b\end{matrix} ] = [ \begin{matrix}X \\ Y \\ Z\end{matrix} ] \qquad ( 3 )$$

Equation (3) can be solved for r, g, and b.

In some cases, CIE 1931 x, y data is available instead of CIE 1931 X, Y, Z data. Y is a measure of illuminance and no less a measure of chromaticity than X and Z (it should be noted that none of X, Y, Z are chromaticity, but X, Y, Z all contribute to chromaticity). However, for the purpose of determining laser power values to achieve a desired white point, Y may be ignored. One way to go from CIE 1931 x, y to r, g, b ratios is to pick an arbitrary Y value. This leaves CIE x, y, Y, which can be easily converted to CIE X, Y, Z. Another approach is to modify Equation (3) by dividing both sides by Y. For example, chromaticity coordinates x, y, z are related to X, Y, Z by the following equations:

$$\begin{matrix}x = \frac{X}{X + Y + Z} & ( 4 a ) \\ y = \frac{Y}{X + Y + Z} & ( 4 b ) \\ z = \frac{Z}{X + Y + Z} & ( 4 c )\end{matrix}$$

Modifying Equation (3) by dividing both sides by Y and substituting in equations for (X, Y, Z) in terms of (x, y, Y) simplify to:

$$[ \begin{matrix}\overline{X} ( {λ}_{r} ) & \overline{X} ( {λ}_{g} ) & \overline{X} ( {λ}_{b} ) \\ \overline{Y} ( {λ}_{r} ) & \overline{Y} ( {λ}_{g} ) & \overline{Y} ( {λ}_{b} ) \\ \overline{Z} ( {λ}_{r} ) & \overline{Z} ( {λ}_{g} ) & \overline{Z} ( {λ}_{b} )\end{matrix} ] [ \begin{matrix}r / Y \\ g / Y \\ b / Y\end{matrix} ] = [ \begin{matrix}x / y \\ 1 \\ ( 1 - x - y ) / y\end{matrix} ] \qquad ( 5 )$$

Equation (5) can be solved for (r/Y, g/Y, b/Y). When comparing the values of r/Y, g/Y, b/Y to each other to calculate ratios of power for one laser in terms of the others, the Y term cancels out. Thus r/Y, g/Y, b/Y can be used in comparing laser power ratios in the same manner that r, g, b would be used.

At 412, the calibration processor determines the r, g, and b corresponding to the measured white point for exit pupil j. For convenience, let rm be the spectral radiance for red light r corresponding to the measured white point for exit pupil j, gm be the spectral radiance for green light g corresponding to the measured white point for exit pupil j, and bm be the spectral radiance for blue light b corresponding to the measured white point for exit pupil j. In one example, the measured white point for exit pupil j is the spectral distribution measured at 410, and rₘ, bₘ, and gₘ may be determined according to the procedure above using CIE 1931 X, Y, Z or CIE x, y data, i.e., by solving Equation (3) or Equation (5). Some commercial spectrometers/spectroradiometers give a breakdown of how much power was recorded at each wavelength (typically in single nanometer increments). In this case, instead of determining rm, bm, and gm from CIE 1931 x, y or X, Y, Z data, the measured power within a couple of nanometers of each of the color's wavelengths could be summed and used to compute rm, bm, and gm.

Also, at 412, the calibration processor determines the r, g, and b corresponding to the target white point. For convenience, let rₜ be the spectral radiance for red light r corresponding to the target white point, gₜ be the spectral radiance for green light g corresponding to the target white point, and bₜ be the spectral radiance for blue light b corresponding to the target white point. In one example, rₜ, gₜ, and bₜ may be determined from the chromaticity coordinates of the target white point. CIE 1931 x, y coordinates are known, for example, for Illuminant D65. Thus, rₜ, gₜ, and bₜ for Illuminant D65 could be determined from the CIE 1931 x, y coordinates by, for example, solving Equation (5).

At 414, the calibration processor determines if the white point of exit pupil j is sufficiently close to the target white point. In one example, to determine if the white point of exit pupil j is sufficiently close to the target white point, a distance in a color space between the chromaticity coordinates of the white point of exit pupil j and the chromaticity coordinates of the target white point is determined. (Alternatively, the distance may be based on RGB values, e.g., if the white point is measured by a camera and RGB values are available.) In this case, the white point of the exit pupil j is sufficiently close to the target white point if the distance is less than a defined distance threshold, which may be predefined. In one example, the distance is the Euclidean distance between the two chromaticity coordinates (or between RGB values). Euclidean distance is the straight-line distance between two points in the Euclidean space. In one non-limiting example, the distance threshold for the Euclidean distance may be 0.01. In another non-limiting example, the distance threshold for the Euclidean distance may be 0.005. For the comparison at 414, the chromaticity coordinates of the white point of exit pupil j and target white point are in the same color space. This may be the CIE 1931 color space, for example. In some cases, it may be advantageous to use a color space other than CIE 1931. For example, CIE 1976 coordinates tend to be more perceptually uniform than CIE 1931 coordinates. This means that a Euclidean distance of 0.1 is roughly the same no matter where the coordinates are in the CIE 1976 color space.

For the purpose of calculating Euclidean distance in CIE 1976 color space, the CIE 1931 X, Y, Z or CIE 1931 x, y coordinates obtained from previous calculations or spectral detector measurements may be converted to CIE 1976 u′, v′ coordinates using the following formulas: (see, “Precise Color Communication: Color Terms,” Konica Minolta, https://www.konicaminolta.com/instruments/knowledge/color/part4/08.html, Web. 22 Jun. 2018):

$$\begin{matrix}{u}^{′} = \frac{4 X}{X + 15 Y + 3 Z} = \frac{4 x}{- 2 x + 12 y + 3} & ( 6 ) \\ {v}^{′} = \frac{9 Y}{X + 15 Y + 3 Z} = \frac{9 y}{- 2 x + 12 y + 3} & ( 7 )\end{matrix}$$

At 416, if the white point of exit pupil j is not sufficiently close to the target white point (e.g., the Euclidean distance between the measured white point of exit pupil j and the target white point is not less than the distance threshold), adjustment to the laser power scale factors is needed such that the white point of exit pupil j after the adjustment is sufficiently close to the target white point. This may also be expressed as minimizing the difference between the measured white point of exit pupil j and the target white point. In one example, to make the measured white point of the exit pupil j be as close as possible to the target white point, the laser power ratios are adjusted.

The following is an example procedure for determining adjustments to laser power ratios. Let:

$$\begin{matrix}ratio {( b , b )}_{t} = \frac{{b}_{t}}{{b}_{t}} = 1 & ( 8 ) \\ ratio {( g , b )}_{t} = \frac{{g}_{t}}{{b}_{t}} & ( 9 ) \\ ratio {( r , b )}_{t} = \frac{{r}_{t}}{{b}_{t}} & ( 10 )\end{matrix}$$

where ratio(b,b)ₜ is a target blue power to blue power ratio, ratio(g,b)ₜ is a target green power to blue power ratio, and ratio(r,b)ₜ is a target red power to blue power ratio, rₜ is target spectral radiance for red light, gₜ is target spectral radiance for green light, and bₜ is target spectral radiance for blue light, where rₜ, gₜ, and bₜ were obtained at 412.

In addition, let:

$$\begin{matrix}ratio {( b , b )}_{m} = \frac{{b}_{m}}{{b}_{m}} & ( 11 ) \\ ratio {( g , b )}_{m} = \frac{{g}_{m}}{{b}_{m}} & ( 12 ) \\ ratio {( r , b )}_{m} = \frac{{r}_{m}}{{b}_{m}} & ( 13 )\end{matrix}$$

where ratio(b,b)ₘ is a measured blue power to blue power ratio, ratio(g,b)ₘ is a measured green power to blue power ratio, and ratio(r,b)ₘ is a measured red power to blue power ratio, rₘ is measured spectral radiance for red light, gₘ is measured spectral radiance for green light, and bₘ is measured spectral radiance for blue light, where rₘ, gₘ, and bₘ were obtained at 412.

The measured power ratios can be compared to the target power ratios according to the following expressions:

$$\begin{matrix}M ( r ) = \frac{{ratio ( r , b )}_{m}}{{ratio ( r , b )}_{t}} & ( 14 ) \\ M ( g ) = \frac{{ratio ( g , b )}_{m}}{ratio {( g , b )}_{t}} & ( 15 ) \\ M ( b ) = \frac{{ratio ( b , b )}_{m}}{{ratio ( b , b )}_{t}} & ( 16 )\end{matrix}$$

where M(r) is a comparison between measured red power ratio and target red power ratio, M(g) is comparison between measured green power ratio and target green power ratio, M(b) is a comparison between measured blue power ratio and target blue power ratio, ratio(r,b)m is described in Equation (13), ratio(g,b)ₘ is described in Equation (12), ratio (b,b)ₘ is described in Equation (11), ratio(r,b)ₜ is described in Equation (10), ratio(g,b)ₜ is described in Equation (9), and ratio(b,b)ₜ is described in Equation (8).

To use Equations (14) to (16) in comparing power ratios, if M(x) is greater than 1, then color x has more relative power than needed; if M(x) is less than 1, then color x has less relative power than needed; if M(x)=1, then color x has the exact relative power needed, where x can be r, g, or b. In the definitions above, M(b)=1. The power reduction needed to minimize the difference between the target white point and the measured white point of exit pupil j can be determined from the following expressions:

$$\begin{matrix}PR ( r ) = \frac{min M}{M ( r )} & ( 17 ) \\ PR ( g ) = \frac{min M}{M ( g )} & ( 18 ) \\ PR ( b ) = \frac{min M}{M ( b )} & ( 19 )\end{matrix}$$

where PR(r) is a red power reduction factor, PR(g) is a green power reduction factor, PR(b) is a blue power reduction factor, minM is the minimum of M(r), M(g), and M(b), M(r) is given by Equation (14), M(g) is given by Equation (15), and M(b) is given by Equation (16). The power reduction factors are now guaranteed to be less than or equal to 1. The color with the least relative power will be unchanged, i.e., reduction will be 1.0. All other colors will have their power reduced.

At 416, the calibration processor may compute the power reduction factors according to Equations (17) to (19). At 418, the method includes adjusting the laser power scale factors by the corresponding power reduction factors, e.g., adjusted Sᵣ=PR(r)×previous Sᵣ, adjusted S_{g}=PR(g)×previous S_{g}, and adjusted S_{b}=PR(b)×previous Sᵣ. The calibration processor provides the adjusted laser power scale factors to the application to store in a memory of the WHUD for future rendering of any display UI into the frame buffer. Acts 402 to 418 may be repeated until at 414, the measured white point of the exit pupil is sufficiently close to the target white point, e.g., the Euclidean distance between the measured white point and the target white point is less than the defined distance threshold.

A single iteration of adjusting the scaling factors (Sᵣ, S_{g}, S_{b}) is guaranteed to leave at least one of the scaling values (Sᵣ, S_{g}, S_{b}) at 1.0, but multiple iterations may end up reducing all the scaling values (Sᵣ, S_{g}, S_{b}), usually due to measurement accuracy. To keep laser power reduction to a minimum, Sᵣ, S_{g}, and S_{b} may be renormalized after the adjustment of 418. That is, after every adjustment to scaling values (Sᵣ, S_{g}, S_{b}) at 418, the scaling values (Sᵣ, S_{g}, S_{b}) are normalized. This is done by finding maxS=max(Sᵣ, S_{g}, S_{b}), i.e., finding the scaling factor with the highest value, and then computing Sᵣ=Sᵣ/maxS, S_{g}=S_{g}/maxS, and S_{b}=S_{b}/maxS. This generally means that at least one of Sᵣ, S_{g}, and S_{b} will have the value 1.0 after normalization. The normalized scaling factors may be provided to the application processor for storage in a memory of the WHUD as previously described.

If at 414 the measured white point of exit pupil j is sufficiently close to target white point, indicating end of the white point calibration of current exit pupil j, then at 420, the processor may check if there are other exit pupils whose white point is to be calibrated. If there are other exit pupils to be calibrated, the process moves to the next exit pupil at 422 and continues at 402 with the next exit pupil. If there are no other exit pupils to be calibrated, the process terminates. The final laser power scale factors for each exit pupil are stored in a memory of the WHUD, e.g., a memory that is accessible to the application processor of the WHUD, for later use in displaying content to the user.

It should be noted that the power reduction factors calculated according to Equations (17) to (19) indicate an amount by which to linearly reduce the power of each color channel, respectively. In cases where a non-linear correction has been applied to the image data and the display output, each of these power reduction factors will need to be converted to a gamma-corrected value so that the desired linear power reduction is achieved when the gamma-corrected power reduction factor is multiplied with pixels in the frame buffer and then a gamma is applied to the pixels in the projector. Thus, storing the set of laser power scale factors in a memory of the WHUD may include storing the raw values of the laser power factors determined at 418 and/or storing the corrected, such as gamma-corrected, values of the laser power factors determined at 418.

The method of FIG. 8 has been described with respect to calibrating the white point of one exit pupil j at a time. However, it is possible to project a display UI, or a respective copy of a display UI, to each of the exit pupils at the same time and sample the color of the display UI, or the color of the respective copy of the display UI, projected to each of the exit pupils at the same time.

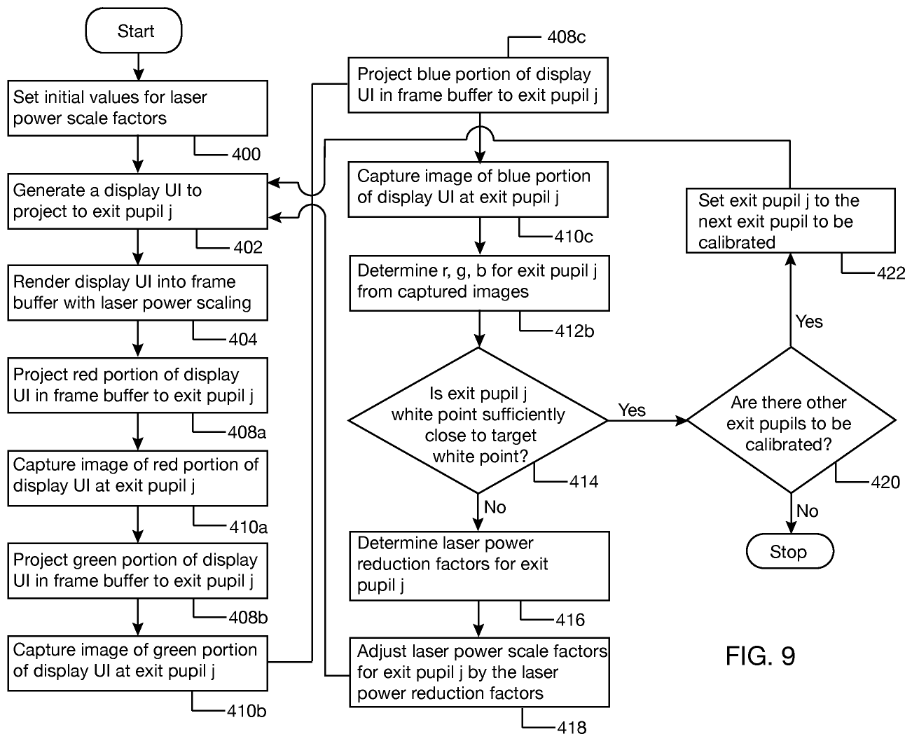

In act 410 of FIG. 8, a camera may be used to measure the white point of the light projected to exit pupil j. There may be slight variations to the measurement process compared to when a spectral detector, such as a spectrometer or spectroradiometer, is used. For example, at 408, the color components of the display UI are projected separately to exit pupil j, and at 410, each projected color component of display UI is captured separately by the camera. This is illustrated in FIG. 9. Acts 400 to 406 and 414 to 422 of FIG. 9 are generally the same as described above for FIG. 8. At 408a in FIG. 9, the display UI is projected to exit pupil j with only the red laser diode turned on. At 410a, the “red display UI” is captured by the camera at the exit pupil j. At 408b, the display UI is projected to exit pupil j with only the green laser diode turned on. At 410b, the “green display UI” is captured by the camera at the exit pupil j. At 408c, the display UI is projected to exit pupil j with only the blue laser diode turned on. At 410c, the “blue display UI” is captured by the camera at the exit pupil j. At 412b, the three images captured by the camera at exit pupil j are used to determine RGB values for exit pupil j. The camera may be a monochrome camera, measuring only the intensity of the light projected to exit pupil j.

A calibrated or an uncalibrated camera may be used to capture images at exit pupil j. In this context, calibrated means that the intensity of a pixel in an image that the camera captures can be mapped to a power measurement of light that hits that part of the camera's sensor. Uncalibrated means the opposite, i.e., the intensity of a pixel in an image that the camera captures cannot be mapped to a power measurement of light that hits that part of the camera's sensor.

An uncalibrated camera may be used because it is not necessary to know the exact power that a pixel intensity is mapped to in order to calculate color using the camera. For example, if the following two things hold, then color can be calculated from the camera: (1) increasing power of incident light on the camera by a certain percent increases the recorded pixel value by the same amount, and (2) the same pixel values for each of red, green, and blue corresponded to the same incident power of light. The camera sensor and lenses each allowed different amounts of power to transmit through them depending on the wavelength of light. That is to say, they had different “spectral sensitivities”. Once the spectral sensitivity of the camera setup is known, the pixel intensities in a captured image can be scaled up or down to make them all have the same linear relationship to laser power. For example, one greyscale image is recorded for each of R, G, B and the RGB pixel at one location is found to be (1, 2, 3). The spectral sensitivity of the camera setup is determined. For example, one setup allows 100% transmission of a specific red wavelength, 50% transmission of a specific blue wavelength, and 25% of a specific green wavelength. Therefore, the measured intensity of red corresponds to 100% of the actual red power, the measured intensity of blue corresponds to 50% of the actual blue power, and the measured intensity of green corresponds to 25% of the actual green power. Therefore, that RGB pixel is scaled to be (1, 4, 12), and this is the actual ratio of the power seen by the camera sensor.

The foregoing detailed description has set forth various implementations or embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation or embodiment, the present subject matter may be implemented via Application Specific Integrated Circuits (ASICs). However, those skilled in the art will recognize that the implementations or embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this disclosure, a “non-transitory processor-readable medium” or “non-transitory computer-readable memory” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples of the processor-readable medium are a portable computer diskette (magnetic, compact flash card, secure digital, or the like), a random-access memory (RAM), a read-only memory (ROM), an erasable programmable read-only memory (EPROM, EEPROM, or Flash memory), a portable compact disc read-only memory (CDROM), digital tape, and other non-transitory medium.

The above description of illustrated embodiments, including what is described in the Abstract of the disclosure, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

1. A method of calibrating a wearable heads-up display having multiple exit pupils, the method comprising:
calibrating a white point of at least one exit pupil to a target white point, the calibrating comprising:
for each pixel of a plurality of pixels of a display user interface (UI), the plurality of pixels having a white color:
generating visible light that is representative of the white color of the pixel by a plurality of light sources of the wearable heads-up display; and
projecting the visible light to the at least one exit pupil by the wearable heads-up display;
determining a measured white point of the at least one exit pupil from at least a portion of the visible light received at the at least one exit pupil; and
determining a set of factors by which to scale a power of each of the plurality of light sources based on minimizing a difference between the measured white point of the at least one exit pupil and the target white point.

2. The method of claim 1, wherein calibrating a white point of at least one exit pupil to a target white point further comprises generating the display UI.

3. The method of claim 1, wherein calibrating a white point of at least one exit pupil to a target white point further comprises storing the set of factors for the at least one exit pupil in a memory.

4. The method of claim 1, further comprising repeating calibrating a white point of at least one exit pupil to a target white point for each of the remaining exit pupils and storing the set of factors for each of the exit pupils in a memory.

5. The method of claim 1, wherein generating visible light that is representative of the white color of the pixel by a plurality of light sources of the wearable heads-up display comprises:
generating a red light that is representative of a red portion of the white color of the pixel by a first one of the plurality of light sources;
generating a green light that is representative of a green portion of the white color of the pixel by a second one of the plurality of light sources; and
generating a blue light that is representative of a blue portion of the white color of the pixel by a third one of the plurality of light sources.

6. The method of claim 5, wherein determining a measured white point of the at least one exit pupil from at least a portion of the visible light received at the at least one of the exit pupils comprises capturing an image represented by the at least a portion of the visible light received at the at least one exit pupil.

7. The method of claim 6, wherein projecting the visible light to the at least one exit pupil by the wearable heads-up display comprises separately projecting each of the red light, the green light, and the blue light to the at least one exit pupil by the wearable heads-up display.

8. The method of claim 7, wherein determining a measured white point of the at least one exit pupil from at least a portion of the visible light received at the at least one exit pupil further comprises measuring relative intensities of the red light, the green light, and the blue light projected to the at least one exit pupil.

9. The method of claim 5, wherein projecting the visible light to the at least one exit pupil by the wearable heads-up display comprises aggregating the red light, the green light, and the blue light into a single combined beam and projecting the single combined beam to the at least one exit pupil by the wearable heads-up display.

10. The method of claim 9, wherein determining a measured white point of the at least one exit pupil from at least a portion of the visible light received at the at least one exit pupil comprises measuring a spectral power distribution of the at least a portion of the visible light.

11. The method of claim 10, wherein determining a measured white point of the at least one exit pupil from at least a portion of the visible light received at the at least one exit pupil further comprises determining chromaticity coordinates of the measured white point in a select color space from the measured spectral power distribution.

12. The method of claim 11, wherein determining a measured white point of the at least one exit pupil from at least a portion of the visible light received at the at least one exit pupil further comprises translating the chromaticity coordinates to r, g, and b values, wherein r is spectral radiance of the red light, g is spectral radiance of the green light, and b is spectral radiance of the blue light.

13. The method of claim 1, wherein determining a set of factors by which to scale a power of each of the plurality of light sources based on minimizing a difference between the measured white point of the at least one exit pupil and the target white point comprises determining a distance in a color space between the measured white point and the target white point.

14. The method of claim 1, wherein calibrating a white point of at least one exit pupil to a target white point includes calibrating the white point of at least one exit pupil to a standard white point representing daylight.

15. The method of claim 14, wherein calibrating a white point of at least one exit pupil to a target white point includes calibrating the white point of at least one exit pupil to CIE Standard Illuminant D65.

16. The method of claim 1, wherein projecting the visible light to the at least one exit pupil by the wearable heads-up display comprises projecting the visible light along a projection path of the wearable heads-up display comprising an optical scanner and a holographic combiner.

17. The method of claim 1, wherein projecting the visible light to the at least one exit pupil by the wearable heads-up display comprises projecting the visible light along a projection path of the wearable heads-up display comprising an optical scanner, an optical splitter having a plurality of facets on a light coupling surface thereof, each facet to receive visible light from the optical scanner for a select subset of a scan range of the optical scanner, and a holographic combiner.

18. A wearable heads-up display calibration system, comprising:
a wearable heads-up display having multiple exit pupils, the wearable heads-up display comprising a scanning laser projector to project light to the exit pupils;
a light detector positioned and oriented to detect visible light projected to at least one of the exit pupils, the light detector to measure a select characteristic of the visible light, the select characteristic including at least one of intensity and spectral power distribution;
a calibration processor communicatively coupled to the wearable heads-up display and light detector; and
a non-transitory processor-readable storage medium communicatively coupled to the calibration processor, wherein the non-transitory processor-readable storage medium stores data and/or processor-executable instructions that, when executed by the calibration processor, calibrates a white point of at least one of the exit pupils to a target white point.

19. The wearable heads-up display calibration system of claim 18, wherein the wearable heads-up display comprises a processor, and wherein the calibration processor is communicatively coupled to the processor of the wearable heads-up display.

20. The wearable heads-up display calibration system of claim 18, wherein the light detector includes at least one of a spectral detector, a camera, and an image sensor.

21. A system for calibrating a wearable heads-up display having multiple exit pupils, the system comprising:
a light detector positioned and oriented to detect visible light projected to at least one exit pupil by the wearable heads-up display, the light detector to measure a select characteristic of the visible light, the select characteristic including at least one of intensity and spectral power distribution;
a calibration processor communicatively coupled to the light detector and the wearable heads-up display; and
a non-transitory processor-readable storage medium communicatively coupled to the calibration processor, wherein the non-transitory processor-readable storage medium stores data and/or processor-executable instructions that, when executed by the calibration processor, cause the system to:
for each pixel of a plurality of pixels of a display user interface (UI), the plurality of pixels having a white color, generate, by a plurality of light sources of the wearable heads-up display, visible light that is representative of the white color of the pixel and project, by the wearable heads-up display, the visible light to at least one exit pupil;
measure, by the light detector, a characteristic of at least a portion of the visible light received at the at least one exit pupil;
determine a measured white point of the at least one exit pupil from the measured characteristic; and
determine a set of factors by which to scale each of the plurality of light sources of the wearable heads-up display based on minimizing a difference between the measured white point and a target white point.

22. The system of claim 21, wherein the non-transitory processor-readable storage medium stores data and/or processor-executable instructions that, when executed by the calibration processor, further cause the system to generate the display UI.

23. The system of claim 21, wherein the non-transitory processor-readable storage medium stores data and/or processor-executable instructions that, when executed by the calibration processor, further cause the system to store the set of factors in a memory associated with the wearable heads-up display.
